(19) United States
(12) Patent Application Publication
(10) Pub. No.: US 2021/0073883 A1
(43) Pub. Date: Mar. 11, 2021

(54) SERVER APPARATUS, STOCK MANAGEMENT SYSTEM, AND STOCK MANAGEMENT METHOD

(71) Applicant: TOSHIBA TEC KABUSHIKI KAISHA, Tokyo (JP)

(72) Inventor: Rika HINO, Shinagawa Tokyo (JP)

(21) Appl. No.: 16/930,016

(22) Filed: Jul. 15, 2020

(30) Foreign Application Priority Data
Sep. 9, 2019 (JP) 2019-163984

(51) Int. Cl. G06Q 30/06; G06Q 10/08

(52) U.S. Cl. CPC G06Q 30/0617; G06Q 50/12; G06Q 10/0875; G06Q 30/0603

(57) ABSTRACT

In accordance with an embodiment, a server apparatus manages stock of a food product owned by a user. The server apparatus includes a communication device, a stock management database, a recipe management database, a storage device, and a controller. The controller calculates, when the controller receives information indicating recipe information of a cooking target from a terminal device of the user via the communication device, a consumption quantity of the food product, which is based on a quantity of the food type specified in the recipe information of the cooking target in the recipe management database. The controller subtracts the calculated consumption quantity from the stock quantity of the food type specified in the recipe information of the cooking candidate in the stock management database.

### CROSS-REFERENCE TO RELATED APPLICATION

This application is based upon and claims the benefit of priority from the prior Japanese Patent Application No. 2019-163984, filed on Sep. 9, 2019, the entire contents of which are incorporated herein by reference.

### FIELD

An embodiment described here generally relates to a server apparatus, a stock management system, and a stock management method.

### BACKGROUND

From the past, a technique for managing food products (ingredients) used in a home has been proposed. For example, in a device called an intelligent refrigerator, the inside of the refrigerator is scanned and information is read from RFID tags (also called IC tags) attached to food products. Thus, the intelligent refrigerator obtains stock information of the food products stored in the refrigerator.

However, the traditional technique lacks in convenience in terms of management of the remaining quantity of a consumed food product. Specifically, in the above-mentioned traditional technique, it is possible to know what food product is present in the refrigerator by reading the RFID tag, but it may be impossible to manage the remaining quantity of the food product. For example, in a case where two pieces of a food product containing six pieces at the time of purchase (e.g., six eggs in a carton) are used, the remaining quantity (stock quantity) cannot be managed by the above-mentioned traditional technique.

### BRIEF DESCRIPTION OF THE DRAWINGS

FIG. 1 is a diagram showing an example of a configuration of a stock management system according to an embodiment.

FIG. 2 is a block diagram showing an example of a hardware configuration of a user terminal according to the embodiment.

FIG. 3 is a block diagram showing an example of a hardware configuration of a stock management server according to the embodiment.

FIG. 4 is a diagram showing an example of a data configuration of a stock management DB according to the embodiment.

FIG. 5 is a diagram showing an example of a data configuration of a user management DB according to the embodiment.

FIG. 6 is a diagram showing an example of a data configuration of a recipe management DB according to the embodiment.

FIG. 7 is a diagram showing an example of a data configuration of a buyer management DB according to the embodiment.

FIG. 8 is a block diagram showing an example of a hardware configuration of a buyer server according to the embodiment.

FIG. 9 is a diagram showing an example of a data configuration of a sales information master according to the embodiment.

FIG. 10 is a diagram showing an example of a functional configuration of the stock management system according to the embodiment.

FIG. 11 is a diagram showing an example of a screen displayed on a display device of the user terminal according to the embodiment.

FIG. 12 is a diagram showing another example of the screen displayed on the display device of the user terminal according to the embodiment.

FIG. 13 is a flowchart showing an example of food product registration processing performed by the user terminal and the stock management server according to the embodiment.

FIG. 14 is a flowchart showing an example of food product consumption processing performed by the user terminal and the stock management server according to the embodiment.

FIG. 15 is a flowchart showing an example of the information providing processing performed by the user terminal and the stock management server according to the embodiment.

FIG. 16 is a flowchart showing an example of point giving processing performed by the stock management server according to the embodiment.

### DETAILED DESCRIPTION

In accordance with one embodiment, a server apparatus manages stock of a food product owned by a user. The server apparatus includes a communication device, a storage device, and a controller. The communication device communicates with a terminal device to be used by the user. The storage device retains a stock management database and a recipe management database. The stock management database storing a stock quantity of the food product in association with a user identifier for identifying the user for each of food types. The recipe management database storing a plurality of pieces of recipe information each specifying a food type and a quantity of a food product specified in a recipe of a dish. The controller selects, on the basis of the stock quantity for each of the food types stored in the stock management database, recipe information of a cooking candidate from among the plurality of pieces of recipe information stored in the recipe management database. The controller sends the selected recipe information of the cooking candidate to the terminal device of the user corresponding to the user identifier via the communication device. The controller calculates, when the controller receives information indicating recipe information of a cooking target from the terminal device of the user via the communication device, a consumption quantity of the food product, which is based on the quantity of the food type specified in the recipe information of the cooking target in the recipe management database. Further, the controller subtracts the calculated consumption quantity from the stock quantity of the food type specified in the recipe information of the cooking candidate in the stock management database.

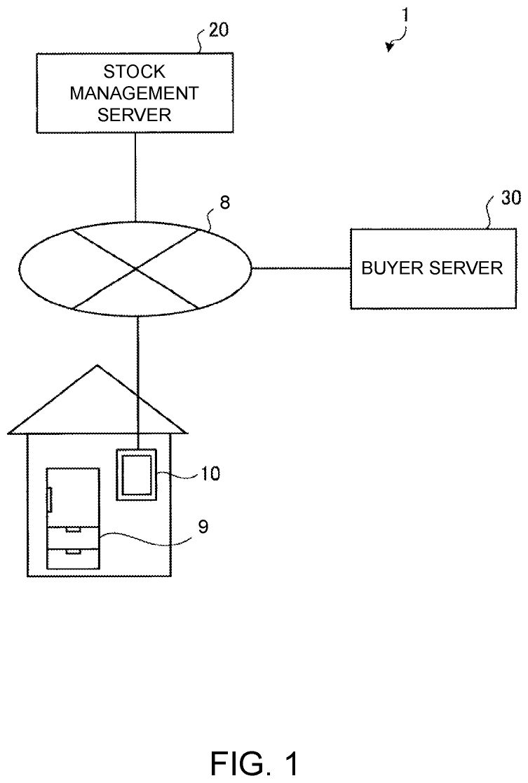

Hereinafter, an embodiment will be described in detail with reference to the drawings. The same reference signs in the drawings will denote the same or similar portions. FIG. 1 shows an example of a configuration of a stock management system according to an embodiment. As shown in FIG. 1, a stock management system 1 includes a user terminal 10, a stock management server 20, and a buyer server 30. The user terminal 10, the stock management server 20, and the buyer server 30 are communicably connected to one another via a network 8 including the Internet, various public networks, and the like. It should be noted that the number of user terminals 10 and buyer servers 30 connected to the network 8 is not limited to the example of FIG. 1.

The user terminal 10 is a terminal device used by a user of the present system. The user terminal 10 is a communication terminal having a communication function such as a tablet computer or a smart phone. In the present embodiment, the user terminal 10 is mainly used in a user's home. For example, the user terminal 10 may be detachably provided in the refrigerator 9, which is a food storage unit.

The stock management server 20 is a server apparatus that manages stock of food product owned by the user, that is, food products (ingredients) existing in the user's home (refrigerator 9) of the present system. Specifically, the stock management server 20 manages the quantity of the food product (stock quantity) existing in the user's home on the basis of various types of information sent from the user terminal 10. In addition, the stock management server 20 selects recipe information of a dish to be a cooking candidate on the basis of stock statuses of food products and the like and provides the recipe information to the user terminal 10. Then, when the stock management server 20 detects that cooking has been performed by the user on the basis of the recipe information, the stock management server 20 subtracts the quantity of a food product specified in the recipe information of the cooked dish from the stock quantity of the corresponding food product as a consumption quantity of the food product.

In addition, the stock management server 20 selects a food product to be a purchase candidate on the basis of the selected recipe information, the food product specified in the recipe information, and the like. Then, the stock management server 20 provides information about the selected food product and information about a buyer who sells the food product to the user terminal 10. Although the stock management server 20 is provided in a company or the like that operates the present system, the present technology is not limited thereto, and may be a cloud realized by cooperating a plurality of server apparatuses connected to a network.

The buyer server 30 is, for example, a store server or the like of each buyer (store) who sells products (food products). The buyer server 30 provides the stock management server 20 with sales information including the prices of food products to be sold at its own store.

Next, a hardware configuration of each device described above will be described.

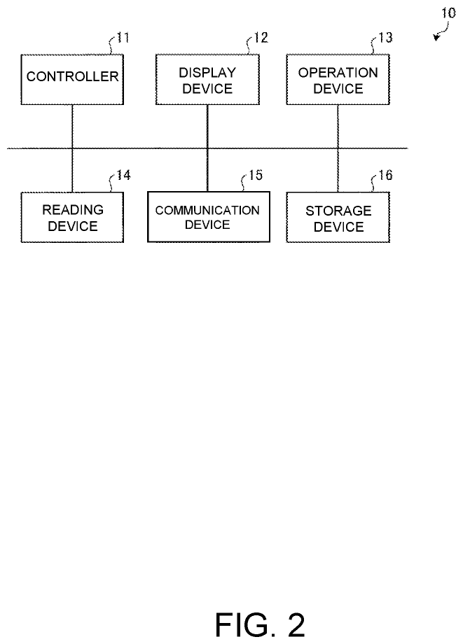

First, the user terminal 10 will be described. FIG. 2 shows an example of a hardware configuration of the user terminal 10. As shown in FIG. 2, the user terminal 10 includes a controller 11 that comprehensively controls various operations and respective blocks of the user terminal 10.

The controller 11 is a computer having a central processing unit (CPU), a read only memory (ROM), a random access memory (RAM), a real time clock (RTC), and the like. The ROM stores various programs and various types of data. The RAM temporarily stores various programs and stores various types of data in a rewritable manner. The RTC clocks the current time and date.

The controller 11 is connected to a display device 12, an operation device 13, a reading device 14, a communication device 15, a storage device 16, and the like via a bus or the like.

The display device 12 is, for example, a device such as a liquid crystal display. The display device 12 displays various types of information (screens) under the control of the controller 11. The operation device 13 includes various operation keys for receiving user input operations. It should be noted that the display device 12 may have a touch panel. In this case, the touch panel functions as the operation device 13.

The reading device 14 is a device for reading, from a food product to be added, information about the food product. Here, the food product to be added is, for example, a food product newly purchased by the user, a food product transferred from another user, or the like that has not been read by the reading device 14.

The reading device 14 is, for example, an imaging device such as a camera, a reader/writer capable of reading radio frequency identifier (RFID) tags, or the like. In a case where the reading device 14 is an imaging device, the reading device 14 reads food information about the food product from a code symbol such as a bar code, a two-dimensional code, or the like attached to the food product. In a case where the reading device 14 is an imaging device, the reading device 14 may capture an image of the appearance of the food product and read a character string included in the captured image as food information. In a case where the reading device 14 is an imaging device, the reading device 14 may recognize the type or the like of the food product from the captured image obtained by capturing an image of the appearance of the food product by using a technique such as general object recognition or the like and may acquire food information about the recognized food product. In this case, the acquisition source of the food information is not particularly limited, and the server apparatus of the buyer from which the food product has been purchased may be used. In a case where the reading device 14 is a reader/writer, the reading device 14 reads food information about the food product from an RFID tag attached to the food product. The food information will be described later.

The communication device 15 is a communication interface that can be connected to the network 8. For example, the communication device 15 may be wired or wirelessly connected to the network 8 via a communication device such as a router provided at the user's home. The communication device 15 communicates with an external device such as the stock management server 20 connected to the network 8 under the control of the controller 11.

The storage device 16 is, for example, an auxiliary storage device such as a hard disk drive (HDD) or a solid state drive (SSD). The storage device 16 stores various programs to be executed by the controller 11 (CPU). The storage device 16 stores a user ID of the user who operates (possesses) the user terminal 10. Here, the user ID is a user identifier for identifying each user. For example, the user ID may be a unique member number issued for each user who uses the present system or may be unique information including, for example, a mail address. In the present embodiment, it is assumed that one user ID is allocated to each user's home.

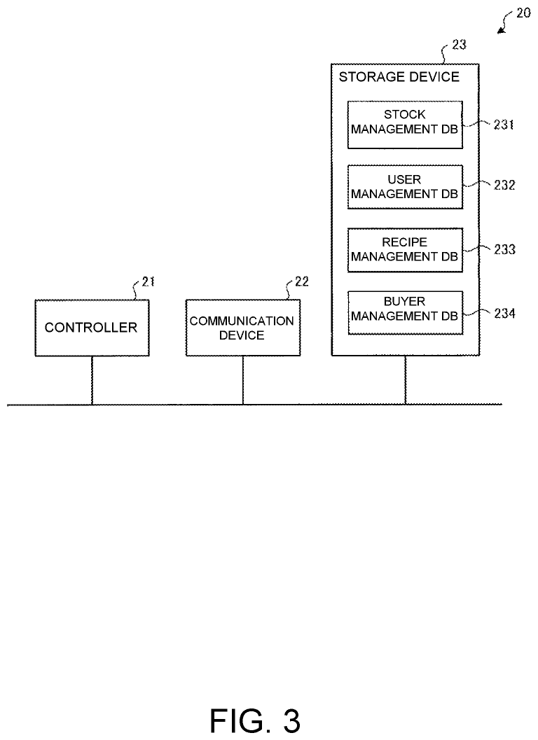

Next, the stock management server 20 will be described. FIG. 3 shows an example of a hardware configuration of the stock management server 20. As shown in FIG. 3, the stock management server 20 includes a controller 21 that comprehensively controls various operations and respective blocks of the stock management server 20.

The controller 21 is a computer having a CPU, a ROM, a RAM, an RTC, and the like. The ROM stores various programs and various types of data. The RAM temporarily stores various programs and stores various types of data in a rewritable manner. The RTC clocks the current time and date.

The controller 21 is connected to a communication device 22, a storage device 23, and the like via a bus or the like. The communication device 22 is a communication interface that can be connected to the network 8. The communication device communicates with an external device such as a user terminal 10 and a buyer server 30 connected to the network 8 under the control of the controller 21.

The storage device 23 is, for example, an auxiliary storage device such as an HDD or an SSD. The storage device 23 stores various programs to be executed by the controller (CPU). As shown in FIG. 3, the storage device 23 stores a stock management database (DB) 231, a user management DB 232, a recipe management DB 233, a buyer management DB 234, and the like relating to the operation of the stock management system 1.

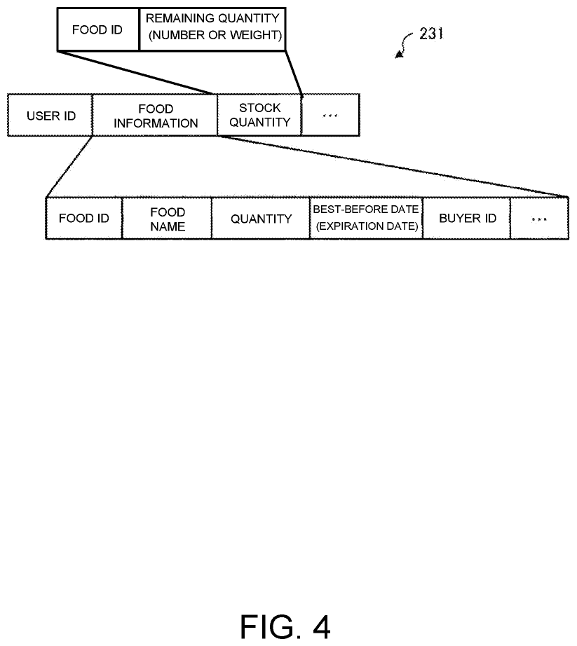

The stock management DB 231 functions as an exemplary management module together with a stock management module 201 to be described later. The stock management DB 231 is a database for managing the stock statuses of food products existing in the user's home. The stock management DB 231 has, for example, a data configuration shown in FIG. 4.

FIG. 4 shows an example of a data configuration of the stock management DB 231. As shown in FIG. 4, the stock management DB 231, stores items such as food information and a stock quantity in association with each user ID for identifying each user.

The food information is information that the reading device 14 of the user terminal 10 reads from the food product. The food information includes, for example, items such as a food ID, a food name, a quantity, a best-before date (expiration date), and a buyer ID. Here, the food ID is a food product identifier for identifying each food type. For example, Japanese Article Number (JAN) codes or the like can be used as the food IDs. The food name is information indicating the name of the food product. The quantity is information indicating the weight and/or content of the food product. The best-before date (expiration date) is date and time information indicating the best-before date and/or the expiration date of the food product. The buyer ID is a buyer identifier for identifying a buyer who sold the food product. It should be noted that the items included in the food information are not limited to the example of FIG. 4. For example, the food information may include items indicating a producer and/or a place of production.

The food information is managed in units of, for example, a food ID. Specifically, when a plurality of pieces of food information having the same food ID are read, information unique to the food product such as the quantity, the best-before date (expiration date), and the buyer ID is registered in association with a common item (food name) such as a food ID. In addition, the stock quantity is information related for each food ID and corresponds to the remaining quantity (number or weight) of the food product corresponding to the food ID

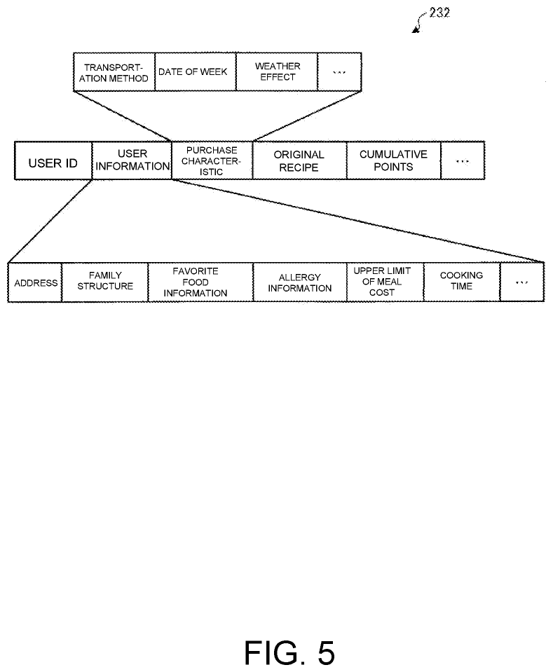

The user management DB 232 is a database for managing information about individual users. The user management DB 232 has, for example, a data configuration shown in FIG. 5.

FIG. 5 shows an example of a data configuration of the user management DB 232. As shown in FIG. 5, the user management DB 232 stores items such as user information, purchase characteristics, original recipes, and cumulative points in association with each user ID of each user.

The user information is information about the user set in advance by each user, and includes items such as an address, a family structure, favorite food information, allergy information, an upper limit of a meal cost, and a cooking time. Here, the address is information indicating the location of the user's home. The family structure is information indicating the family structure of the user and, for example, information including, for example, four members (family) is set in the item of the family structure. The favorite food information is information indicating a user's favorite food product, and, for example, information including, for example, a recipe name and a food name is set in the item of the favorite food information. The allergy information is information indicating whether or not the user has a food allergy, and in a case where the user has a food allergy, the food name and food ID of the causative food product (allergen) are set in the items of allergy information. As the upper limit of the meal cost, an upper limit value of the meal cost per meal is set. The number of hours estimated as a cooking time necessary for cooking for one meal is set in the item of the cooking time.

It should be noted that the contents set in the item of the user information are not limited to the above examples. For example, information about the user's name and a special day such as the birthday and the like may be set in the item of the user information. Further, the eating-out rate per unit period such as one week or one month may be set in the item of the user information. Further, information in a field (special sale product, new product, or the like), which is desired to be provided, out of the information about the food products (products) provided from the stock management server 20 may be set in the item of the user information.

The purchase characteristic is information indicating a characteristic relating to the purchase of a food product set in advance by each user, and includes, for example, items such as a transportation method, a day of the week, a weather effect, and the like. Here, a method of transporting the food purchased at the store to the user's home (e.g., a car, a bicycle, a foot, a carry-back, or the like) is set in the item of the transportation method. The day of the week on which the purchase frequency is high is set in the item of the day of the week. The degree of influence due to the weather is set in the item of the weather effect. For example, purchasing at a distant store on a day of sunny weather, purchasing at a nearby store on a day of rain weather, and the like are set in the item of the weather effect.

The recipe information of the dish generated by the user or a recipe ID for identifying the recipe information is registered in the item of the original recipe. It should be noted that the recipe information will be described later. The cumulative value of points given to the user having the user ID is recorded in the item of the cumulative points. Such points are service points given to the user of the stock management system 1, and can be used for exchanging with a prize or for discount service in a store, for example.

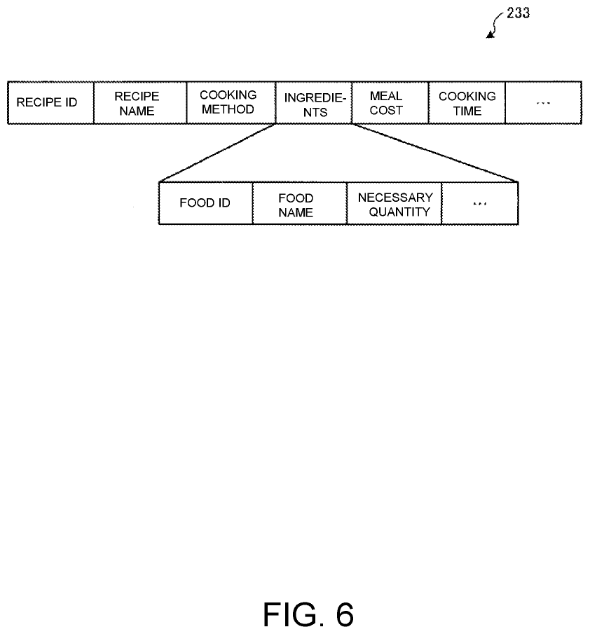

The recipe management DB 233 is a database for managing recipe information. The recipe management DB 233 has, for example, a data configuration shown in FIG. 6.

FIG. 6 shows an example of a data configuration of the recipe management DB 233. As shown in FIG. 6, the recipe management DB 233 stores items such as a recipe name, a cooking method, ingredients, a meal cost, and a cooking time in association with each recipe ID. The recipe ID is an identifier for identifying each recipe (dish) type. The recipe name is information indicating the name of the recipe. The cooking method is information indicating a cooking method (procedure) of the recipe.

Information about a food product necessary for the recipe is specified in the item of the ingredient. For example, the item of the ingredient includes items such as a food ID, a food name, a necessary quantity, and the like of a food product to be used for cooking. Here, the quantity of the food product to be used is set in the item of the necessary quantity. It should be noted that the quantity of the food product necessary for cooking of a predetermined unit number of persons (e.g., one, two, or the like) is set in the item of the necessary quantity.

An estimated amount of money necessary for cooking for the unit number of persons is set in the item of the meal cost. An estimated time necessary for cooking for the unit number of persons is set in the item of the cooking time.

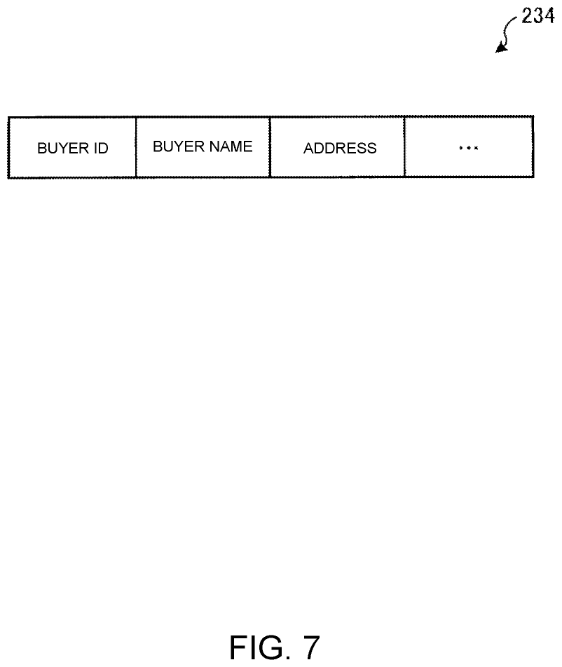

The buyer management DB 234 is a database for managing buyer information about each buyer. The buyer management DB 234 has, for example, a data configuration shown in FIG. 7.

FIG. 7 shows an example of a data configuration of a buyer management DB 234. As shown in FIG. 7, the buyer management DB 234 stores items such as a buyer name and an address in association with each buyer ID. The buyer ID is an identifier for identifying each store (buyer). The buyer name is information indicating the name of the store. The address is information indicating the location of the store.

Next, the buyer server 30 will be described.

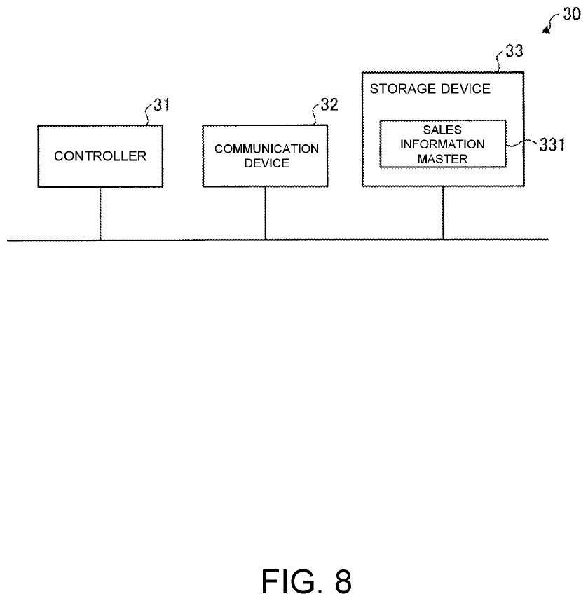

FIG. 8 shows an example of a hardware configuration of the buyer server 30. As shown in FIG. 8, the buyer server 30 includes a controller 31 that comprehensively controls various operations and respective blocks of the buyer server 30.

The controller 31 is a computer having a CPU, a ROM, a RAM, an RTC, and the like. The ROM stores various programs and various types of data. The RAM temporarily stores various programs and stores various types of data in a rewritable manner. The RTC clocks the current time and date.

The controller 31 is connected to a communication device 32, a storage device 33, and the like via a bus or the like. The communication device 32 is a communication interface that can be connected to network 8. The communication device 32 communicates with the external device such as the stock management server 20 connected to the network 8 under the control of the controller 31.

The storage device 33 is, for example, an auxiliary storage device such as an HDD or an SSD. The storage device 33 stores various programs to be executed by the controller (CPU). Further, the storage device 33 stores a buyer ID for identifying a store where its own device is placed (hereinafter, also referred to as its own store). The storage device 33 stores a sales information master 331 and the like.

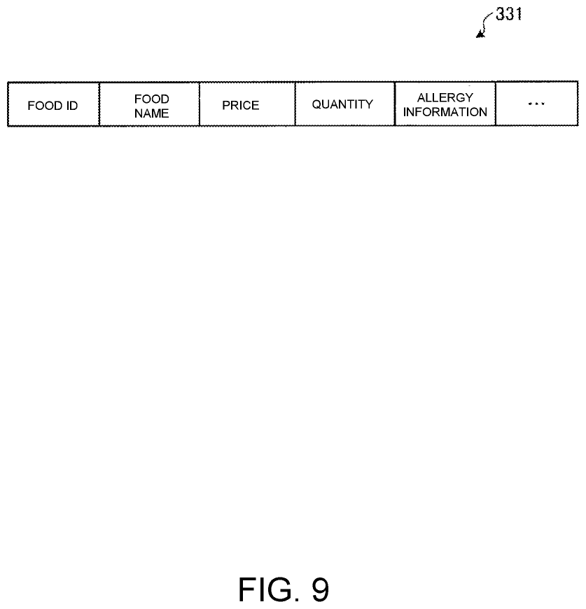

The sales information master 331 is a database for managing sales information about each product (food product) sold at its own store. The sales information master 331 has, for example, a data configuration shown in FIG. 9.

FIG. 9 shows an example of the data configuration of the sales information master 331. As shown in FIG. 9, the sales information master 331 stores items such as a food name, a price, a quantity, and allergen information in association with each food ID. Here, the food ID and the food name correspond to the food ID and the food name of the food product sold at its own store. The price is the price of the food product sold at its own store. The quantity is the weight and/or content of the food product. The allergen information is information indicating allergens contained in food products and allergens (food name, food ID, etc.) that may be mixed in the production process of food products.

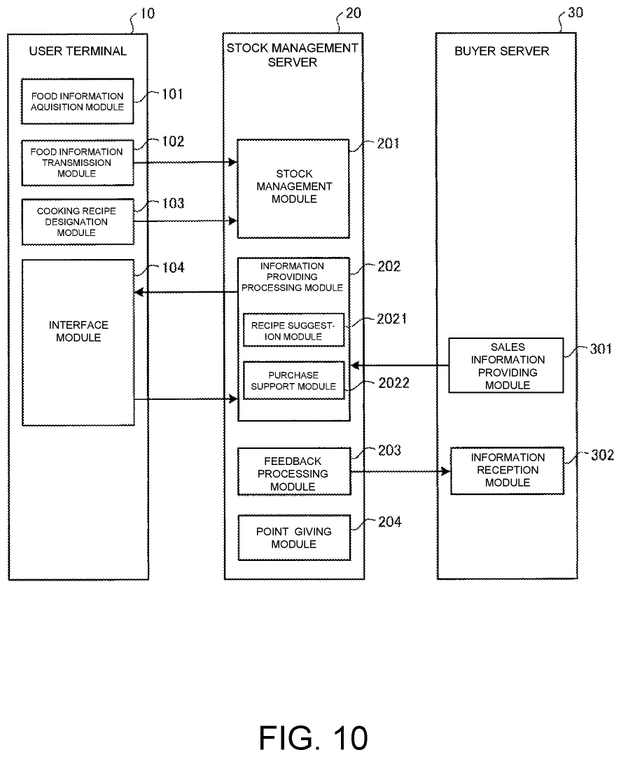

Next, the functional configuration of each of the above-mentioned apparatuses will be described. FIG. 10 shows an example of the functional configuration of the stock management system 1.

First, a functional configuration of the user terminal 10 will be described. As shown in FIG. 10, the controller 11 of the user terminal 10 includes a food information acquisition module 101, a food information transmission module 102, a cooking recipe designation module 103, and an interface module 104 as functional modules. Such a functional module may be a software configuration realized by the CPU of the controller 11 executing a program of the storage device 16 or may be a hardware configuration realized by a dedicated circuit.

The food information acquisition module 101 cooperates with the reading device 14 to obtain the food information read by the reading device 14 from the food product. The food information transmission module 102 is an example of a transmission means. The food information transmission module 102 sends the food information obtained by the food information acquisition module 101 to the stock management server 20 together with the user ID stored in its own device via the communication device 15.

For example, when storing the food product to be added in the refrigerator 9, the user who operates the user terminal 10 causes the reading device 14 to read the product information of the product. In accordance with this operation, the food information acquisition module 101 obtains the food information read by the reading device 14. The food information transmission module 102 sends the food information obtained by the food information acquisition module 101 to the stock management server 20 together with the user ID via the communication device 15. The stock management server 20 adds the quantity of the food product read by the reading device 14 to the stock quantity of the corresponding food product by the function of the stock management module 201 to be described later. In this way, the stock status of the food products stored in the refrigerator 9 is managed by the stock management server 20.

The cooking recipe designation module 103 designates the recipe ID of the recipe (recipe information) of the dish cooked by the user to the stock management server 20. Specifically, the cooking recipe designation module 103 receives an operation (hereinafter, also referred to as a recipe determination operation) of designating determination of a recipe or to complete cooking according to a recipe from a user via an interface module 104 to be described later. When the cooking recipe designation module 103 receives the recipe determination operation, the cooking recipe designation module 103 sends the recipe ID of the recipe to the stock management server 20 via the communication device together with the number of persons for indicating how many people the cooking was for and the user ID.

Here, a recipe of a dish that is a cooking target may be a recipe provided (proposed) from the stock management server 20 or may be a recipe created by the user himself/herself and registered in the user management DB 232. The recipe of the dish that is the cooking target may be a recipe provided by a third party connected to the network 8. In a case where the recipe provided by the third party is used, the cooking recipe designation module 103 may transmit recipe information of the recipe to the stock management server 20 instead of the recipe ID.

For example, when the user who operates the user terminal 10 selects a desired recipe via the operation device 13, the user cooks by using the food products stored in the refrigerator 9. It should be noted that when the recipe is selected, the number of persons indicating how many people the cooking is for is input via the operation device 13. When the cooking is completed, the user performs an operation for designating completion of cooking to the operation device 13. In accordance with this operation, the cooking recipe designation module 103 sends the recipe ID of the selected recipe, the number of persons, and the user ID to the stock management server 20 via the communication device 15. Accordingly, the stock management server 20 subtracts the quantity of each food product consumed by cooking from the stock quantity by the function of the stock management module 201 to be described later.

The interface module 104 cooperates with the display device 12 and the operation device 13 to display (output) various types of information and receive inputs from the user. For example, the interface module 104 causes the display device 12 to display a screen for displaying information about a recipe of a dish to be a cooking candidate on the basis of various types of information provided from the stock management server 20. Further, the interface module 104 causes the display device 12 to display a screen for displaying information for supporting the food purchase on the basis of various types of information provided from the stock management server 20.

Next, a functional configuration of the stock management server 20 will be described. As shown in FIG. 10, the controller 21 of the stock management server 20 includes the stock management module 201, an information providing processing module 202, a feedback processing module 203, and a point giving module 204 as functional modules. Such a functional module may be a software configuration realized by the CPU of the controller 21 executing a program of the storage device 23 or may be a hardware configuration realized by a dedicated circuit.

The stock management module 201 manages the stock statuses of the food products at each user's home using the stock management DB 231 on the basis of the information sent from each user terminal 10. Specifically, when the stock management module 201 receives a set of the food information and the user ID from the user terminal 10, the stock management module 201 registers the food information in the stock management DB 231 in association with the user ID. In addition, the stock management module 201 adds the value of the quantity included in the food information to the stock quantity (as shown in FIG. 4) associated with the same food ID as the registered food information.

Further, when the stock management module 201 receives a set of the recipe ID, the number of persons, and the user ID from the user terminal 10, the stock management module 201 refers to the recipe management DB 233 and the like. Then, the stock management module 201 calculates the consumption quantity corresponding to the designated number of persons from the necessary quantity of each food product set in the item of the ingredient of the designated recipe ID (the recipe management DB 233 of FIG. 6). Specifically, the stock management module 201 calculates the designated number of persons/unit number of persons. Then, the stock management module 201 calculates the consumption quantity of the food product used in the cooking by multiplying the necessary quantity of the food product indicated in the item of the recipe ID by the calculated number of persons/unit number of persons. Then, the stock management module 201 refers to the entry (registered contents of the stock management DB 231 or the like in FIG. 4) related to the designated user ID and subtracts the value of the consumption quantity calculated for the food product from the stock quantity of each food product (food ID) set as the ingredient of the recipe ID.

Further, when the recipe information provided by the third party is sent from the user terminal 10, the stock management module 201 calculates the consumption quantity of each food product from information including, for example, the name of the food product, the necessary quantity, and the unit number of persons included in the recipe information. Then, the stock management module 201 refers to the entry related to the designated user ID and subtracts the quantity of the consumption quantity calculated for the food product from the stock quantity of each food product (food ID) set as the ingredient of the recipe ID.

It should be noted that, with respect to the food information of the food product the stock quantity of which is zero, the entry of the corresponding food ID may be entirely deleted from the stock management DB 231. Further, with respect to the food information of the food product the stock quantity of which becomes zero, the remaining food information may be deleted from the stock management DB 231 while the items such as the food ID that can be continuously used and the stock quantity (zero) are retained.

When subtracting the consumption quantity from the stock quantity, the quantity corresponding to the consumption quantity may be subtracted from the food information of the corresponding food product. For example, the stock management module 201 may subtract the quantity of consumption calculated for a certain food product (food ID) from the quantity of any food information registered in association with the food ID. In this case, it is favorable that the stock management module 201 subtracts the quantity corresponding to the consumption quantity from the food information having the earliest best-before date (expiration date). In addition, the stock management module 201 may delete the food information of the food product the quantity of which has become zero from the stock management DB 231.

The information providing processing module 202 is an example of a providing means. The information providing processing module 202 provides various types of information to the user terminal 10 by sending it via the communication device 22. As an example, the information providing processing module 202 provides, in response to a request from the user terminal 10, the food information of the stock management DB 231 registered in association with the user ID corresponding to the user terminal 10, the stock quantity, and the like to the user terminal 10. As another example, the information providing processing module 202 provides the user terminal 10 with the original recipe (recipe information) of the user management DB 232 registered in association with the user ID corresponding to the user terminal 10 in response to a request from the user terminal 10. It should be noted that when providing the original recipe to the user terminal 10, the information providing processing module 202 may provide an insufficient food product and its shortage calculated by comparing the ingredients included in the original recipe with the stock statuses of the corresponding user's food products.

As shown in FIG. 10, the information providing processing module 202 includes a recipe suggestion module 2021, a purchase support module 2022, and the like. The recipe suggestion module 2021 is an example of a first selection means and performs processing related to selection of a recipe of a dish to be a cooking candidate. Specifically, the information providing processing module 202 selects a recipe of a dish to be a cooking candidate from among the recipes registered in the recipe management DB 233 or the like on the basis of the registered contents of the various DBs stored in the storage device 23. It should be noted that a method of selecting a recipe is not limited to the above example and various methods can be employed.

For example, the recipe suggestion module 2021 selects a recipe ID of a recipe from the recipe management DB 233 on the basis of the stock statuses of the food products registered in the stock management DB 231 and the family structure registered in the user management DB 232, the recipe enabling a dish for the number of persons indicated as the family structure to be prepared. In this case, the recipe suggestion module 2021 may select a recipe ID of a recipe including ingredients all of which can be supplied from the food products in stock or may select a recipe ID of a recipe including ingredients some of which can be supplied from the food products in stock.

Further, for example, the recipe suggestion module 2021 may select, from the recipe management DB 233, a recipe ID using a recipe name or a food name set in the favorite food information on the basis of the contents of the favorite food information registered in the user management DB 232. Further, for example, the recipe suggestion module 2021 may select a recipe ID corresponding to the condition from the recipe management DB 233 on the basis of the condition of the upper limit of the meal cost and/or the cooking time for the user registered in the user management DB 232. It should be noted that the recipe suggestion module 2021 favorably restricts the recipe IDs to be selected on the basis of the history of the recipe IDs sent from the user terminal 10 such that the recipe IDs of the same dish and the recipe IDs of similar dishes are not consecutive.

Further, for example, the recipe suggestion module 2021 may preferentially select a recipe ID of a recipe using a food product of close expiration on the basis of the best-before date (expiration date) of each food product registered in the stock management DB 231. For example, the recipe suggestion module 2021 may preferentially select a recipe ID of a recipe not using a food product set in the allergy information on the basis of the allergy information registered in the user management DB 232.

The purchase support module 2022 is an example of a second selection means and a third selection means. The purchase support module 2022 selects a food product to be a purchase candidate and performs processing related to selection of a buyer from which the selected food product can be purchased. Here, a method of selecting a food product and a method of selecting a buyer are not particularly limited and various methods can be employed.

For example, the purchase support module 2022 compares the ingredients for the family members, which are associated with the recipe ID selected by the recipe suggestion module 2021, with the stock quantities of the food products registered in the stock management DB 231. Then, on the basis of the comparison result, the purchase support module 2022 determines whether or not the ingredients (food products) necessary for cooking can be supplied from the stock. Then, in a case where the ingredients (food products) necessary for cooking cannot be supplied from the stock, the purchase support module 2022 selects the food ID of the insufficient food product as a food ID of a purchase candidate. In this case, the purchase support module 2022 refers to the sales information master 331 of each buyer server 30 and determines whether or not the sales information relating to the food ID of the purchase candidate is registered. Then, the purchase support module 2022 selects the buyer of the buyer server 30 in which the sales information relating to the food ID of the purchase candidate is registered and obtains the sales information from the buyer server 30.

In addition, the purchase support module 2022 may select a buyer on the basis of the user information and/or purchase characteristic registered in the user management DB 232, the buyer information registered in the buyer management DB 234, and the like as well as the above-mentioned selection condition. For example, the purchase support module 2022 may select a buyer existing within a predetermined distance from the user's home on the basis of the address set in the user information and the address of each buyer (store) set in the buyer information. Further, for example, the purchase support module 2022 may select a buyer existing within a distance range to the transportation method from the address of the user on the basis of the transportation method set in the purchase characteristic. Further, for example, the purchase support module 2022 may switch the buyer to select in accordance with the day of the week and/or the weather set in the purchase characteristic and the day of the week and/or the weather of the day. In this case, the purchase support module 2022 may use weather information provided by a third party such as the Meteorological Authority.

The food product selected by the purchase support module 2022 as the purchase candidate is not limited to the food product specified in the recipe ID selected by the recipe suggestion module 2021, and may be another food product. For example, the purchase support module 2022 may set food products the stock quantities of which are less than a threshold as purchase candidates on the basis of the stock status of the food products registered in the stock management DB 231. In addition, for example, the purchase support module 2022 may select a food product having a high tendency to be purchased at the same time as a purchase candidate on the basis of the purchase tendency of the food purchased by each user. Further, for example, the purchase support module 2022 may select a food product as a purchase candidate on the basis of a purchase cycle of the food product to be purchased (added) periodically. Further, for example, the purchase support module 2022 may select a food product that is a special sale product sold at a particularly low price and/or a new product as a purchase candidate on the basis of information or the like provided from each buyer server 30. In this case, it is favorable that the purchase support module 2022 selects food products according to the field in which information provision is desired, which is set in the item of user information of the user management DB 232.

It should be noted that in a case where the allergy information is set in the item of the user information of the user management DB 232, it is favorable that the purchase support module 2022 performs exclusive control such that the set food products are not purchase candidates. Specifically, the purchase support module 2022 determines whether or not the setting contents of the item of the allergy information correspond to the contents of the allergen information included in the sales information of the food product selected as the purchase candidate or the food product of the purchase candidate. Here, in a case where the contents of the allergen information included in the sales information of the food product selected as the purchase candidate or the food product as the purchase candidate correspond to the setting contents of the item of the allergy information, the purchase support module 2022 discards the selected purchase candidate and selects another food product such as an alternative food product as the purchase candidate.

On the basis of the processing results of the recipe suggestion module 2021 and the purchase support module 2022 described above, the information providing processing module 202 provides the user terminal 10 with suggestion information including recipe information of the recipe of the cooking candidate, sales information of the food product as the purchase candidate, information about the buyer who sells the food product, and the like. The user terminal 10 receives the suggestion information provided from the stock management server 20 causes the display device 12 to display a screen showing the contents of the suggestion information by the function of the interface module 104.

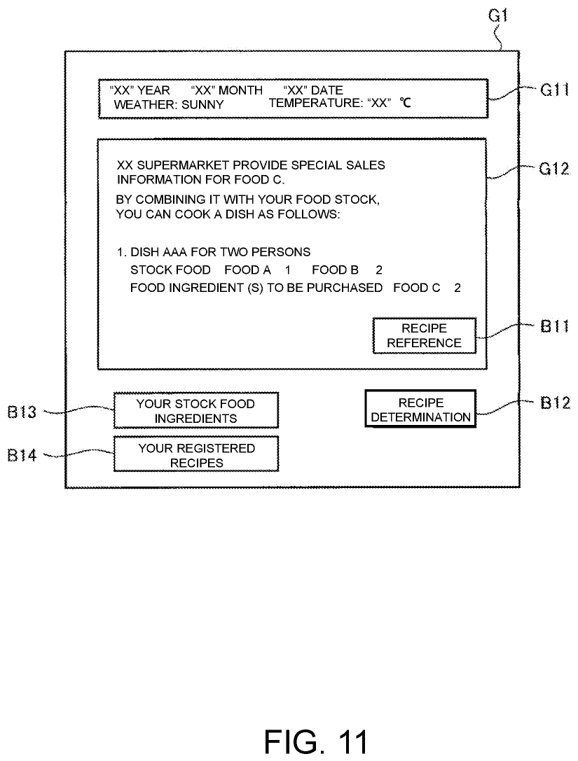

FIG. 11 shows an example of a screen displayed on the display device 12 of the user terminal 10. A screen G1 shown in FIG. 11 is an example of the screen based on the suggestion information and includes a first display region G11 and a second display region G12.

Here, the first display region G11 is a region for displaying information about the current date and time, weather, temperature, and the like. The information displayed in the first display region G11 is obtained by the user terminal 10 from an external server such as the RTC or the Japan Meteorological Agency.

The second display region G12 is a region for displaying the contents of the information provided from the stock management server 20. FIG. 11 shows an example in which information about the recipe “Dish AAA” selected by the recipe suggestion module 2021 is displayed in the second display region G12. Specifically, the quantities of the ingredients (food products) for two persons set in the item of the family structure of the user information (the user management DB 232 in FIG. 5) are displayed in the second display region G12 in such a manner that the ingredients (food products) are divided into food products (a food product A, a food product B) registered in the stock management DB 231 and an insufficient food product (food product C).

FIG. 11 shows an example in which the contents based on the sales information of the food product C obtained by the purchase support module 2022 is displayed in the second display region G12. Specifically, the buyer name “XX Supermarket” selected on the basis of the user information, the purchase characteristic, and the like, and the contents (special sales information) based on the sales information obtained from the buyer server 30 of the buyer are displayed in the second display region G12. In this case, the interface module 104 may display detailed sales information including, for example, the price of the food product C on the condition that the “special sales information” is selected.

In the second display region G12, a button B11 for designating recipe reference is displayed. When the interface module 104 receives an operation of the button B11, the interface module 104 displays detailed recipe information including, for example, the cooking method of “Dish AAA” in the second display region G12.

On the screen G1, a button B12 for designating determination of a recipe of a dish that is a cooking target, a button B13 for designating display of the stock food products, and a button B14 for designating display of the original recipe are displayed.

When the interface module 104 receives an operation of the button B12, the interface module 104 sets the recipe ID of the recipe displayed in the second display region G12 as a recipe ID of a recipe of the cooking target. It should be noted that the interface module 104 may receive the operation of the button B12 as an operation of designating completion of cooking.

Further, when the interface module 104 receives an operation of the button B13, the interface module 104 cooperates with the information providing processing module 202 of the stock management server 20, to thereby cause the display device 12 to display the stock statuses of the food products registered in the stock management DB 231. Specifically, when the interface module 104 receives an operation of the button B13, the interface module 104 sends information for requesting the stock status and the user ID of its own device to the stock management server 20 via the communication device 15. The information providing processing module 202 of the stock management server 20 reads the food information and the stock quantity of each of the food products stored in the stock management DB 231 in association with the user ID when the stock status is requested from the user terminal 10. Then, the information providing processing module 202 provides the read food information and the stock quantity to the user terminal 10 that has requested it by sending it via the communication device 22. The interface module 104 of the user terminal 10 displays a screen showing the stock status on the display device 12 on the basis of the obtained food information and stock quantity of each of the food products.

Further, when the interface module 104 receives an operation of the button B14 the interface module 104 cooperates with the information providing processing module 202 of the stock management server 20 to thereby cause the display device 12 to display the original recipe registered in the user management DB 232. Specifically, when the interface module 104 receives an operation of the button B14, the interface module 104 sends the information for requesting the original recipe and the user ID of its own device to the stock management server 20 via the communication device 15. The information providing processing module 202 of the stock management server 20 reads the original recipe (recipe information) stored in the user management DB 232 in association with the user ID when the original recipe is requested from the user terminal 10, and provides the read original recipe (recipe information) to the user terminal 10 that has requested it by sending it via the communication device 22. The interface module 104 of the user terminal 10 causes the display device 12 to display a screen on which the original recipe can be selected on the basis of the obtained recipe information.

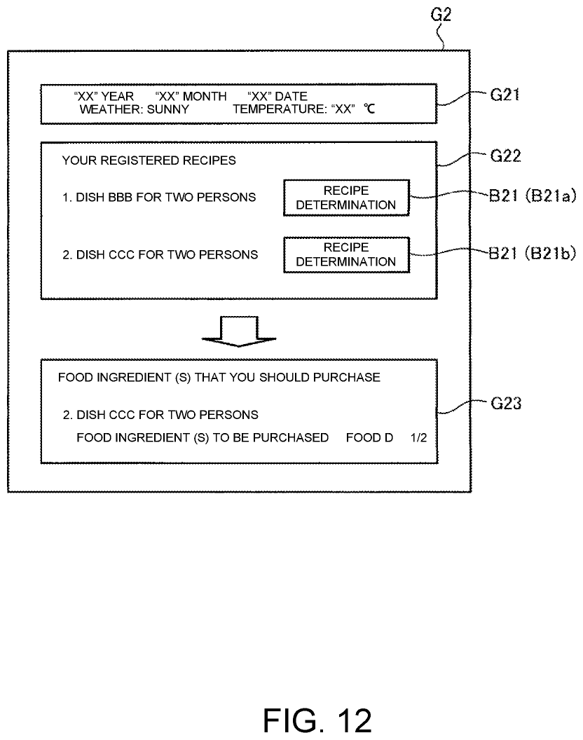

FIG. 12 shows another example of the screen displayed on the display device 12 of the user terminal 10.

The screen G2 shown in FIG. 12 is an example of a selection screen of the original recipe displayed in response to the operation of the button B14 shown in FIG. 11.

As shown in FIG. 12, the screen G2 has a first display region G21 and a second display region G22. Here, the first display region G21 is a display region similar to the first display region G11 described above. The second display region G22 corresponds to the selection screen of the original recipe.

FIG. 12 shows an example in which recipes of “Dish BBB” and “Dish CCC” registered in advance as original recipes are displayed in the second display region G22. Here, buttons B21 (B21a, B21b) for designating determination of a recipe of a dish that is a cooking target are displayed in association with the respective recipes in the second display region G22.

When the interface module 104 receives an operation of either one of the buttons B21, the interface module 104 sets the recipe ID of the recipe corresponding to the operated button B21 as a recipe ID of a recipe of the cooking target in the same way as the button B12 described above. It should be noted that FIG. 12 shows an example in which the “Dish CCC” is selected as the cooking target, and information indicating a shortage quantity of an insufficient ingredient (food product D) is displayed in a third display region G23.

In this manner, the stock management system 1 causes the display device 12 of the user terminal 10 to display a recipe of a dish to be a cooking candidate on the basis of the information provided from the stock management server 20. As a result, the user can cook the dish according to the recipe selected on the basis of the stock status without considering the stock status of the food products stored in the refrigerator 9. Therefore, the stock management system 1 can improve the convenience in the stock management of the food product and improve the convenience for the user in the recipe determination.

The description returns to FIG. 10. The stock management server 20 further includes a feedback processing module 203 and a point giving module 204. The feedback processing module 203 is a functional module for providing the buyer server 30 with various analysis results obtained by interacting with the user terminal 10.

For example, the feedback processing module 203 analyzes the tendency of the food purchased during the predetermined period for each area where the user's residence exists, on the basis of the food information sent from the user terminal 10 of each user during the predetermined period. Then, the feedback processing module 203 provides, on the basis of the buyer management DB 234, the purchase tendency of the food product analyzed for each region to the buyer server 30 of the store corresponding to the region by sending it via the communication device 22. As a result, the buyer server 30 can obtain the purchase tendency of the food product in the region where its own store exists, and can thus be used for sales promotion activities and the like.

It should be noted that the information provided by the feedback processing module 203 is not limited to the above example. For example, the feedback processing module 203 may analyze the tendency of the user information and/or the purchase characteristic of each user for each region, and provide the analysis result to the buyer server 30 corresponding to the region.

Further, the feedback processing module 203 may provide the buyer server 30 with information about each user stored in the stock management DB 231 and the user management DB 232. In this case, for example, it is favorable that an item indicating whether or not information can be provided is provided to the user information of each user, and that the feedback processing module 203 provides information only to the user for whom information indicating that information can be provided is set.

The point giving module 204 is a function module for giving points to the user. Specifically, the point giving module 204 gives points by adding a value of given points to the cumulative points of the user management DB 232 associated with the user ID of the corresponding user.

It should be noted that the point giving condition and the point giving rate are not particularly limited and can be arbitrarily set. For example, a setting may be made such that points are given to the user when the action of the user satisfies a predetermined condition. As an example, the point giving module 204 may give the user the number of points according to the price of the food product on condition that the food product as the purchase candidate included in the suggestion information provided (proposed) by the information providing processing module 202 is purchased at the store of the buyer designated by the sales information. In this case, the point giving module 204 compares a set of the food ID of the food product as the purchase candidate and the buyer ID included in the suggestion information provided to the user terminal 10 with a set of the food ID and the buyer ID of the food information sent from the user terminal 10 after the provision of the suggestion information. Then, the point giving module 204 determines that the food product is purchased on the basis of the suggestion information about the condition that the sets of the food ID and the buyer ID match, and gives points to the user of the user terminal 10.

In this manner, the stock management server 20 is capable of giving points to the user in accordance with the user's purchasing behavior. Therefore, the stock management system 1 can enhance the motivation of the user for the purchase of the food product and can support the promotion activity of the buyer who participates in the stock management system 1.

It should be noted that the point giving condition is not limited to the above example. For example, in return for providing, by the feedback processing module 203, information about the user stored in the stock management DB 231 and/or the user management DB 232 to the buyer server 30, the point giving module 204 may give points to the user.

Next, a functional configuration of the buyer server 30 will be described. As shown in FIG. 10, the buyer server 30 includes a sales information providing module 301 and an information reception module 302 as functional modules. Such a functional module may be a software configuration realized by the CPU of the controller 31 executing a program of the storage device 33 or may be a hardware configuration realized by a dedicated circuit.

The sales information providing module 301 provides the stock management server 20 with the buyer ID and the sales information master 331 stored in the storage device 33 in a referable manner. It should be noted that the sales information providing module 301 may read the sales information of the food ID designated from the stock management server 20 from the sales information master 331 and provide the read sales information to the stock management server 20.

The information reception module 302 receives feedback information and the like provided from the stock management server 20. For example, the information reception module 302 stores the feedback information provided from the stock management server 20 in the storage device 33 or the like.

Hereinafter, an operation example of the above-mentioned stock management system 1 will be described.

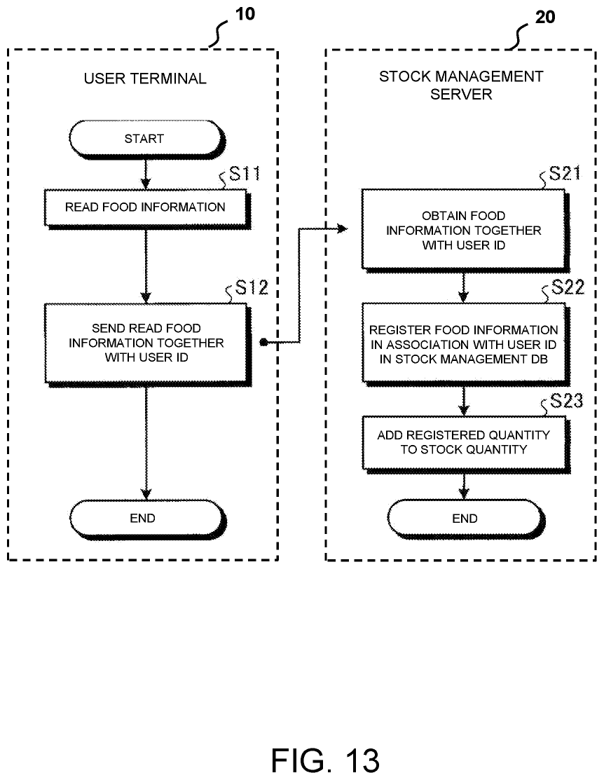

First, a procedure of food product registration processing performed by the user terminal 10 and the stock management server 20 will be described with reference to FIG. 13. FIG. 13 shows an example of the food product registration processing performed by the user terminal 10 and the stock management server 20.

In the user terminal 10, the food information obtaining module 101 of the controller 11 operates the reading device when the user designates reading of the food product through the operation device 13 or the like. In this state, in Step S11 shown in FIG. 13, when the food product to be read is brought close to the reading device 14 by the user, the food information obtaining module 101 of the controller 11 obtains the food information read by the reading device 14 from the food product. Next, in Step S12, the food information transmission module 102 of the controller 11 sends the food information obtained by the food information obtaining module 101 together with the user ID to the stock management server 20 via the communication device 15.

On the other hand, in the stock management server 20, the communication device 22 receives a set of the food information and the user ID. In Step S21 shown in FIG. 13, the controller 21 obtains a set of the food information and the user ID via the communication device 22. Next, in Step S22, the stock management module 201 of the controller 21 registers the obtained food information in the stock management DB 231 (FIG. 4) in association with the user ID obtained as the same time. In Step S23, the stock management module 201 adds the quantity included in the food information registered in Step S22 to the stock quantity. Here, as described above, the stock quantity is the information associated with each food ID and corresponds to the remaining quantity (number or weight) of the food product corresponding to the food ID Therefore, the stock management module 201 adds the quantity included in the food information to the remaining quantity corresponding to the food ID included in the food information.

According to the processing shown in FIG. 13, in the stock management server 20, the food information of the food product read by the reading device 14 is registered in the stock management DB 231 and the quantity of the food product is added to the stock quantity. For example, when the user stores food products purchased at the buyer in the refrigerator 9, the user uses the reading device 14 for reading food information for each food product. By this reading, the food information of the respective food products stored in the refrigerator 9 is registered in the stock management DB 231.

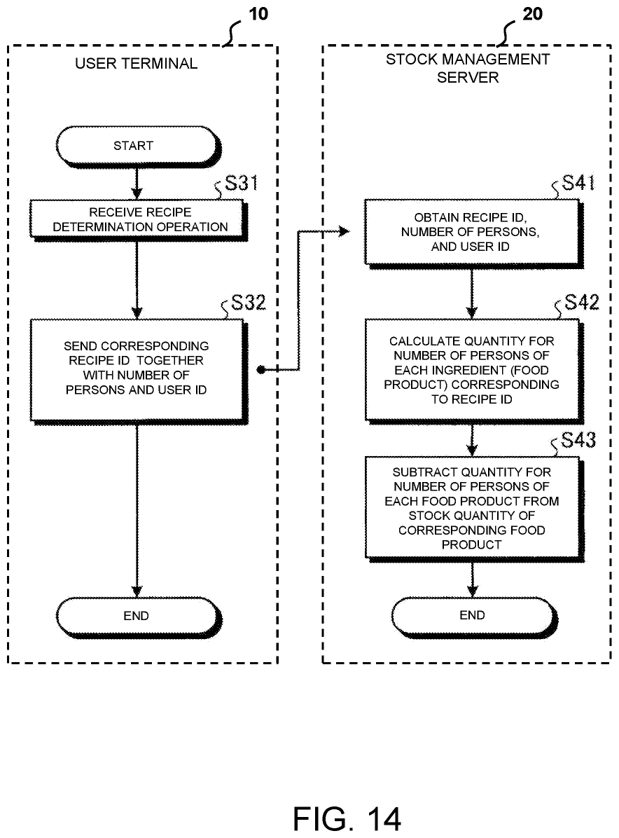

Next, a procedure of food product consumption processing performed by the user terminal 10 and the stock management server 20 will be described with reference to FIG. 14. FIG. shows an example of the food product consumption processing performed by the user terminal 10 and the stock management server 20. As a premise of the processing shown in FIG. 14, a screen (e.g., FIG. 11) for determining a recipe of a dish that is a cooking target has been displayed on the display device 12.

In Step S31 shown in FIG. 14, the cooking recipe designation module 103 of the controller 11 of the user terminal 10 receives a recipe determination operation via the operation device 13 or the like. Next, in Step S32, the cooking recipe designation module 103 sends the recipe ID of the recipe corresponding to the received recipe determination operation together with the number of persons and the user ID to the stock management server 20 via the communication device 15.

On the other hand, in the stock management server 20, the communication device 22 receives a set of the recipe ID, the number of persons, and the user ID from the stock management server 20. In Step S41 shown in FIG. 14, the controller 21 obtains a set of the recipe ID, the number of persons, and the user ID via the communication device 22. Next, in Step S42, the stock management module 201 of the controller 21 refers to the recipe management DB 233 (FIG. 6). Then, the stock management module 201 calculates the quantity (consumption quantity) for the number of persons of each ingredient (food product) associated with the recipe ID. Next, in Step S43, the stock management module 201 subtracts the calculated quantity of each of the food products from the stock quantities of the corresponding food products (food ID) stored in the stock management DB 231 (FIG. 4) in association with the user ID.

According to the processing shown in FIG. 14 described above, in the stock management server 20, the consumption quantity of each food product cooked on the basis of the recipe information is subtracted from the stock quantity of the stock management DB 231. As a result, the user of the user terminal 10 can subtract the consumption quantity of each food product used for cooking from the stock quantity of the corresponding food product managed by the stock managing DB 231 only by designating the cooked recipe.

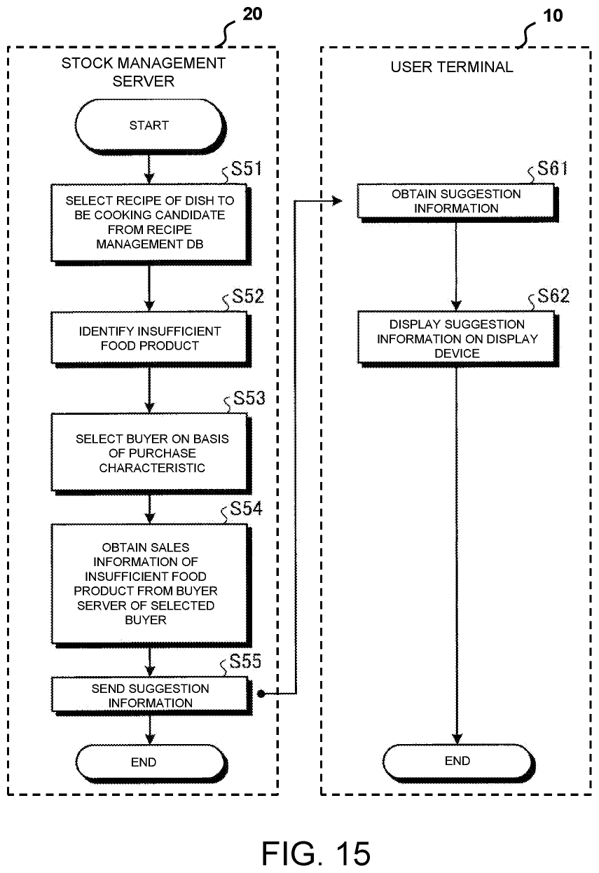

Next, a procedure of information providing processing performed by the user terminal 10 and the stock management server 20 will be described with reference to FIG. 15. FIG. 15 shows an example of the information providing processing performed by the user terminal 10 and the stock management server 20.

First, in the stock management server 20, in Step S51 shown in FIG. 15, the recipe suggestion module 2021 of the controller 21 selects a recipe of a dish to be a cooking candidate from the recipe management DB 233 (FIG. 6) for each user on the basis of the information of each user stored in the stock management DB 231 (FIG. 4) and the user management DB 232 (FIG. 5). Here, the timing at which the recipe suggestion module 2021 performs the processing of Step S51 is not particularly limited. For example, the recipe suggestion module 2021 may set the processing of Step S51 to be performed at a predetermined time.

Subsequently, in Step S52, the purchase support module 2022 of the controller 21 identifies (selects) an insufficient food product for each user as a purchase candidate on the basis of each ingredient (food product) of the recipe selected by the recipe suggestion module 2021 and its quantity, and the stock quantity of the corresponding food product stored in the stock management DB 231.

Subsequently, in Step S53, the purchase support module 2022 selects, for each user, a buyer from which sales information is to be obtained from among the buyers stored in the buyer management DB 234 (FIG. 7) on the basis of the user information and the purchase characteristic of each user stored in the user management DB 232 (FIG. 5). Next, in Step S54, the purchase support module 2022 obtains the sales information of the food product identified in the processing of Step S52 from the buyer server 30 of the selected buyer.

Subsequently, in Step S55, the information providing processing module 202 of the controller 21 sends the suggestion information to the user terminal 10 of each user via the communication device 22 on the basis of the processing results of the recipe suggestion module 2021 and the purchase support module 2022. The sent suggestion information includes recipe information of the recipe of the dish as the cooking candidate, sales information of the food product as the purchase candidate, and the like.

On the other hand, in the user terminal 10, the communication device 12 receives the suggestion information from the stock management server 20. In Step S61 shown in FIG. 15, the controller 11 obtains the suggestion information via the communication device 12. Next, in Step S62, the interface module 104 of the controller 11 causes the display device 12 to display a screen based on the suggestion information.

According to the processing shown in FIG. 15, in the user terminal 10, the suggestion information from the stock management server 20, that is, the recipe information selected by the recipe suggestion module 2021 and the sales information of the food product selected by the purchase support module 2022 are displayed on the display device 12. Thus, the user of the user terminal 10 can easily select the recipe of the dish that is the cooking target on the basis of the recipe information displayed on the display device 12. In addition, the user of the user terminal 10 can confirm the buyer from which the user can purchase the insufficient product, the price of the product, and the like on the basis of the sales information displayed on the display device 12.

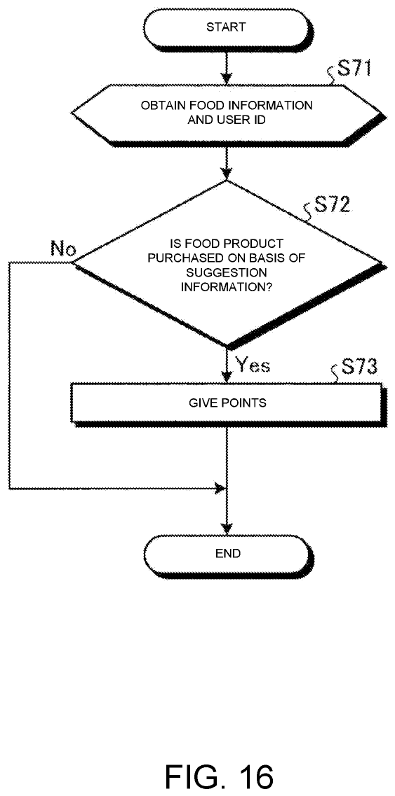

Next, a procedure of point giving processing performed by the stock management server 20 will be described with reference to FIG. 16. FIG. 16 shows an example of the point giving processing performed by the stock management server 20. It should be noted that the processing shown in FIG. 16 is performed in the background of the stock management server 20 described with reference to FIG. 13.

First, in the stock management server 20, the communication device 22 receives a set of the food information and the user ID. In Step S71 shown in FIG. 16, the controller 21 obtains a set of the food information and the user ID from the user terminal 10 via the communication device 22. Next, in Step S72, the point giving module 204 of the controller 21 determines whether or not the food product (food ID) included in the food information obtained from the user terminal 10 is a food purchased on the basis of the suggestion information. Specifically, in a case where the food ID and the buyer ID of the suggestion information provided to the user terminal 10 of the user ID by the information providing processing module 202 are included in the food information obtained from the user terminal 10, the point giving module 204 determines that the food product is purchased on the basis of the suggestion information.

Here, in a case where the point giving module 204 determines that the food product included in the food information obtained from the user terminal 10 is the food purchased on the basis of the suggestion information (Yes in Step S72), the processing of the controller proceeds to Step S73. In Step S73, the point giving module 204 of the controller 21 gives points corresponding to the purchase quantity of the food product to the user ID of the corresponding user. In a case where the point giving module 204 determines that the food information obtained from the user terminal 10 is not the food purchased on the basis of the suggestion information (No in Step S72), the point giving module 204 ends the processing shown in FIG. 16 without giving points.

According to the processing shown in FIG. 16, the stock management server 20 is capable of giving points to the user in accordance with the purchasing behavior of the user performed on the basis of the suggestion information. Therefore, the stock management server 20 can enhance the motivation for the user of the user terminal 10 to purchase the food product. In addition, the stock management server can support the promotion activity of the buyer who participates in the stock management system 1.

As described above, the stock management server 20 manages, for each food ID, the stock quantity of the food product existing in the user's home (the refrigerator 9) in association with the user ID for identifying the user. Further, the stock management server 20 selects recipe information as a cooking candidate from a plurality of pieces of recipe information each specifying the food ID and the quantity of the food product to be used, on the basis of the stock quantity for each food ID. Further, the stock management server 20 provides the selected recipe information to the user terminal 10 corresponding to the user ID. When recipe information of a dish that is a cooking target is designated from the user terminal 10, the stock management server 20 subtracts the stock quantity associated with the food ID stored in the stock management DB 231 on the basis of the quantity associated with the food ID specified in the recipe information.

As a result, the stock management system 1 (the stock management server 20) can subtract the quantity of the food product consumed by cooking from the stock quantity of the food product, such that the remaining stock quantity (contents quantity) can be managed. For example, when the user uses two pieces of a food product containing six pieces at the time of purchase (e.g., six eggs in a carton), the remaining four eggs can be managed as the stock quantity in the stock management system 1 of the present embodiment, and it is thus possible to improve the convenience in the stock management of the food products.

Further, the user of the user terminal 10 can cook the dish according to the recipe selected on the basis of the stock status without considering the stock status of the food products stored in the refrigerator 9. Therefore, it is possible to improve the convenience for the user in the recipe determination as well as the convenience in the stock management of the food product.

Further, when the food information is sent from the user terminal 10, the stock management server 20 adds the quantity associated with the food ID included in the food information added to the stock quantity associated with the food ID stored in association with the user ID corresponding to the user terminal 10. As a result, in the stock management system 1, additional registration of food product can be easily performed, and thus the convenience in the stock management of the food product can be improved.

Further, the stock management server 20 selects the food ID of the food product as the purchase candidate on the basis of the food ID used in the recipe information regarding the dish selected as the cooking candidate. Then, the stock management server 20 provides the user terminal 10 with the sales information of the selected food ID and the information about the buyer who sells the food product of the food ID. As a result, in the stock management system 1, the user terminal 10 can be provided with the sales price of the food product as the purchase candidate and the purchase source thereof, and thus the purchase support of the food product can provided to the user.

In addition, the stock management server 20 selects a buyer who sells the food product as the purchase candidate from among a plurality of buyers on the basis of preset purchase characteristic of the user or the like. Then, the stock management server 20 provides the information about the selected buyer to the user terminal 10 together with the sales information of the food product as the purchase candidate. As a result, in the stock management system 1, the user terminal 10 can be provided with the purchase source according to the purchase characteristic of each user, and it is thus possible to more efficiently perform the purchase support of the food product to the user.

It should be noted that in the embodiment described above, the user terminal 10 is separate from the refrigerator 9, but may be configured integrally with the refrigerator 9. In this case, the user terminal 10 may be a so-called intelligent refrigerator or may automatically read the food information from the RFID tag of the food products stored in the refrigerator 9.

In addition, in the above-mentioned embodiment, the stock management of the food products stored in the refrigerator 9 is performed, though the place where the food product is stored is not limited thereto. For example, the place where the food product is stored may be a food product storage, a wine cellar, or the like. Further, the entire user's home may be a place where the food product is stored, such that the stock of the food product existing in the user's home can be managed.

It should be noted that the program executed by each apparatus of the above-mentioned embodiment is provided by being incorporated in advance in a storage medium (ROM or storage device) of each apparatus, though the embodiment is not limited thereto. For example, the program may be provided in an installable or executable file recorded on a computer readable storage medium. Examples of such a storage medium can include a CD-ROM, a flexible disk (FD), a CD-R, and a digital versatile disk (DVD). Further, the storage medium is not limited to a medium independent of the computer or the embedded system. For example, the storage medium includes a storage medium that is stored or temporarily stored by downloading a program sent through a LAN, the Internet, or the like.

The program executed by each apparatus of each of the above-mentioned embodiment may be provided or distributed via a network such as the Internet.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A server apparatus that manages stock of a food product owned by a user, comprising:
a communication device that communicates with a terminal device to be used by the user;
a storage device that retains a stock management database and a recipe management database, the stock management database storing a stock quantity of the food product in association with a user identifier for identifying the user for each of food types, the recipe management database storing a plurality of pieces of recipe information each specifying a food type and a quantity of a food product specified in a recipe of a dish; and
a controller that
selects, on a basis of the stock quantity for each of the food types stored in the stock management database, recipe information of a cooking candidate from among the plurality of pieces of recipe information stored in the recipe management database,
sends the selected recipe information of the cooking candidate to the terminal device of the user corresponding to the user identifier via the communication device,
calculates, when the controller receives information indicating recipe information of a cooking target from the terminal device of the user via the communication device, a consumption quantity of the food product, which is based on the quantity of the food type specified in the recipe information of the cooking target in the recipe management database, and
subtracts the calculated consumption quantity from the stock quantity of the food type specified in the recipe information of the cooking candidate in the stock management database.

2. The server apparatus according to claim 1, wherein
the controller further
obtains food information including the food type and the quantity of the food product via the communication device from the terminal device of the user, and
adds the quantity of the food type included in the obtained food information to the stock quantity of the food type included in the food information out of the food types stored in the stock management database in association with the user identifier corresponding to the user who uses the terminal device.

3. The server apparatus according to claim 2, wherein
the stock management database further stores buyer information about a buyer who sells the food product for each of the food types, and
the controller further
selects a food type of a purchase candidate on a basis of the food type specified in the selected recipe information of the cooking candidate out of the plurality of pieces of recipe information stored in the recipe management database, and
sends the selected food type of the purchase candidate and the buyer information of the selected food type of the purchase candidate stored in the stock management database to the terminal device of the user via the communication device.

4. The server apparatus according to claim 3, wherein
the storage device further retains a user management database, the user management database storing a characteristic associated with purchase of the food product of the user in association with the user identifier, and
the controller further selects, on a basis of the characteristic associated with the purchase of the food product of the user which is stored in the user management database, buyer information of the selected food type of the cooking candidate from the buyer information stored in the stock management database.

5. A stock management method for a server apparatus that manages stock of a food product owned by a user, comprising:
causing a storage device to retain a stock management database storing a stock quantity of the food product for each of food types in association with a user identifier for identifying the user;
causing the storage device to retain a recipe management database storing a plurality of pieces of recipe information each specifying a food type and a quantity of a food product specified in a recipe of a dish;
selecting a recipe information of a cooking candidate from among the plurality of pieces of recipe information stored in the recipe management database on a basis of the stock quantity for each of the food types stored in the stock management database;
sending the selected recipe information of the cooking candidate to the terminal device of the user corresponding to the user identifier via the communication device;
calculating, when receiving information indicating recipe information of a cooking target from the terminal device of the user via the communication device, a consumption quantity of the food product, which is based on the quantity of the food type based on the quantity of the food type specified in the recipe information of the cooking target in the recipe management database; and
subtracting the calculated consumption quantity from the stock quantity of the food type specified in the recipe information of the cooking candidate in the stock management database.

6. A stock management system, comprising:
a terminal device to be used by a user; and
a server apparatus that manages stock of a food product owned by the user, wherein
the terminal device of the user includes
a first communication device that communicates with the server apparatus, and
a first controller that sends food information indicating the food type and the quantity of the food product to the server apparatus via the first communication device, and
the server apparatus includes
a second communication device that communicates with a terminal device to be used by a user,
a storage device that retains a stock management database and a recipe management database, the stock management database storing a stock quantity of the food product in association with a user identifier for identifying the user for each of food types, the recipe management database storing a plurality of pieces of recipe information each specifying a food type and a quantity of a food product specified in a recipe of a dish, and
a second controller that
receives the food information from the terminal device of the user via the second communication device,
adds to the quantity of the food type included in the received food information to the stock quantity of the food type stored in the stock management database in association with the user identifier corresponding to the terminal device of the user,
selects the recipe information of the cooking candidate from among a plurality of pieces of recipe information stored in the recipe management database on a basis of the stock quantity for each of the food types stored in the stock management database,
sends the selected recipe information of the cooking candidate to the terminal device of the user corresponding to the user identifier via the second communication device,
calculates, when the second controller receives information indicating recipe information of a cooking target from the terminal device of the user via the second communication device, a consumption quantity of the food product based on the quantity of the food type specified in the recipe information of the cooking target in the recipe management database, and
subtracts the calculated consumption quantity from the stock quantity of the food type specified in the recipe information of the cooking target in the stock management database.

7. The stock management system according to claim 6, wherein
the terminal device of the user further includes a reading device that reads the food information of the food product owned by the user, and
the first controller sends the food information read by the reading device to the server apparatus via the first communication device.

8. The stock management system according to claim 6, wherein
the terminal device of the user further includes an operation device that receives a determination operation for the recipe by the user, and
the first controller sends the recipe information of the recipe for which the determination operation is received the operation device to the server apparatus via the first communication device.

9. The stock management system according to claim 6, wherein
the stock management database further stores buyer information of a buyer who sells the food product for each of the food types, and
the second controller further
selects a food type of a purchase candidate on a basis of the food type specified in the selected recipe information of the cooking candidate out of the plurality of pieces of recipe information stored in the recipe management database, and
sends the selected food type of the purchase candidate and the buyer information of the selected food type of the purchase candidate stored in the stock management database to the terminal device of the user via the second communication device.

10. The stock management system according to claim 9, wherein
the storage device further retains a user management database, the user management database storing a characteristic associated with purchase of the food product of the user in association with the user identifier, and
the second controller further selects, on a basis of the characteristic associated with the purchase of the food product of the user which is stored in the user management database, buyer information of the selected food type of the cooking candidate from the buyer information stored in the stock management database.
